(19) United States
(12) Patent Application Publication
(10) Pub. No.: US 2013/0048579 A1
(43) Pub. Date: Feb. 28, 2013

(54) Ceramic Filter with Nanofibers

(71) Applicants: Jeffery J. Haslam, Livermore, CA (US); Mark A. Mitchell, Dublin, CA (US)

(72) Inventors: Jeffery J. Haslam, Livermore, CA (US); Mark A. Mitchell, Dublin, CA (US)

(73) Assignee: Lawrence Livermore National Security, LLC, Livermore, CA (US)

(21) Appl. No.: 13/598,125

(22) Filed: Aug. 29, 2012

Related U.S. Application Data
(60) Provisional application No. 61/529,117, filed on Aug. 30, 2011.
(60) Provisional application No. 61/535,285, filed on Sep. 15, 2011.

(51) Int. Cl. B01D 29/00; B01D 37/00; B82Y 30/00

(52) U.S. Cl. 210/808; 210/489; 210/767; 977/778

(57) ABSTRACT

A filter system for filtering a fluid containing particles includes a porous substrate. The porous substrate is made of a porous ceramic material. A filtering material is connected to the porous ceramic substrate. The filtering material includes nanofibers. The fluid travels through the porous ceramic substrate and travels through the filtering material wherein the particles are captured in the porous ceramic substrate and in the filtering material.

### CROSS-REFERENCE TO RELATED APPLICATIONS

This application claims benefit under 35 U.S.C. §119(e) of U.S. Provisional Patent Application No. 61/529,117 filed Aug. 30, 2011 entitled “Application and Use of Nanofibers in Relation to Ceramic Filters” and U.S. Provisional Patent Application No. 61/535,285 filed Sep. 15, 2011 entitled “Method and Fabrication of a Radiological/Biological/Aerosol Removal Device,” the disclosures of which are hereby incorporated by reference in their entirety for all purposes.

### STATEMENT AS TO RIGHTS TO INVENTIONS MADE UNDER FEDERALLY SPONSORED RESEARCH AND DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### BACKGROUND

1. Field of Endeavor

The present invention relates to filters and more particularly to a ceramic filter with nanofibers.

2. State of Technology

United States Published Patent Application No. 2006/0169633 is for a ceramic filter. United States Published Patent Application No. 2006/0169633 is incorporated herein in its entirety for all purposes. United States Published Patent Application No. 2006/0169633 includes the state of technology information quoted below.

“A ceramic filter is a filter utilizing a ceramic porous body and is superior in physical strength, durability, corrosion resistance and the like. Therefore, the filter is used in removing suspension substances, bacteria, powder dust and the like in liquid or gas, for example, in water treatment, exhaust gas treatment, or broad fields such as pharmaceutical and food fields.”

“In the ceramic filter, the ceramic porous body is used as a filtering material as it is in some cases, but, in general, on the surface of the porous body (substrate) made of a ceramic, a filtration membrane made of the ceramic as well is formed in order to enhance both of a filtering performance and a fluid permeation amount (i.e., treatment ability). For example, a mean pore diameter of the filtration membrane is constituted to be small at about 0.01 to 1.0 μmuμ to secure the filtering performance. On the other hand, a mean pore diameter of the substrate is constituted to be large at about 1 μm to several hundreds of micrometers. Accordingly, a flow resistance to fluidity inside the substrate is lowered, and the fluid permeation amount (i.e., treatment ability) is enhanced.”

“Moreover, there is used a ceramic filter whose substrate is worked into a certain shape in accordance with a filtration purpose, and there is used for a general purpose a ceramic filter whose substrate is formed into a tubular shape having a single flow path, or a honeycomb shape (including a monolith shape) having a large number of parallel flow paths. The filter having a filtration membrane formed on the surface of the tubular or honeycomb-shaped substrate, for example, on an inner wall surface of the flow path is housed in a housing and is structured in such a manner that a substrate outer peripheral surface side is airtightly isolated from a substrate end face side, in which the flow paths open, via an O-ring or the like. Accordingly, the filter is utilized as a cross flow type or a dead end type filter.”

“Furthermore, in a large-sized ceramic filter, the body is ruptured in such a manner that predetermined flow paths communicate with an external space, and accordingly slit-shaped auxiliary flow paths (voids) are formed in some cases (see, e.g., JP-A-2000-153117). In a ceramic filter having such structure, since it is easy to recover purified fluid from the flow paths in the vicinity of a central portion of the porous body, a filtering process ability can greatly be enhanced, and further a flow rate distribution in the filter is preferably uniform.”

United States Published Patent Application No. 2006/0216464 is for a ceramic filter. United States Published Patent Application No. 2006/0216464 is incorporated herein in its entirety for all purposes. United States Published Patent Application No. 2006/0216464 includes the state of technology information quoted below.

“A ceramic filter is useful as a filter for solid-liquid separation in that the filter is superior in physical strength and durability, and is highly reliable as compared with a polymer membrane or the like, and is also superior in resistance to corrosion. Furthermore, the precise control of pore diameters which determine a filtering ability becomes possible.”

“The ceramic filter performs filtration using as a filtering material a ceramic porous body processed into a variety of the shape such as a flat plate shape, a tubular shape or the like. A so-called monolithic ceramic filter 21 is broadly utilized in which, as shown in FIG. 2, a porous body 22 made of a ceramic is provided with a large number of flow passages (cells) 23 of a stock solution (fluid to be purified), because a filtering area per unit volume is large, and a filtering ability is high.”

“When the monolithic ceramic filter is used, the only porous body constituting a substrate is used as the filtering material. Alternatively, from a viewpoint that a filtering performance is enhanced while securing a water passing amount, ceramic filtration membranes (hereinafter referred to simply as the “filtration membranes”) are formed on inner wall surfaces of the flow passages (cells). The filtration membranes have smaller pore diameters as compared with those of pores in the porous body constituting the substrate.”

“As to the cell (main flow passage) for this ceramic filter, a quadrangular cell is generally used as a shape (cell shape) of a cross section perpendicular to a flow direction of the fluid to be purified, because the filtering area per unit volume can be increased. However, to facilitate counter flow washing, it is assumed that a preferable cell is a polygonal cell such as a pentagonal cell or more (e.g., hexagonal cell or the like), or a cell which does not have any corner portion, such as a circular cell.”

“The ceramic filter is a kind of honeycomb structure, and can therefore be manufactured by a method similar to that for another honeycomb structure, in which clay of materials for forming the honeycomb structure is extruded, dried, and thereafter fired. However, the above-described cells like the polygonal cell and the circular cell have low strengths against a force from a direction crossing the flow direction at right angles, and therefore have had a problem that the cell or the ceramic filter itself is easily crushed and deformed by a weight of an extruded material or an external force such as vibration generated in an extruding step or a subsequent step (firing step, etc.).”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention includes both the application and the use of nanofibers in relation to ceramic filters. The nanofibers are supported by ceramic elements and/or substrates providing better physical properties (e.g., strength). The ceramic elements are selected for desired filtration related properties, e.g., high porosity (low pressure drop, high flow rate, and low weight) as well as other physical and chemical properties that may be beneficial to an application (e.g., corrosion resistance, temperature resistance, fire resistance). The porous ceramic material provides a ceramic element of high porosity producing low pressure drop and is of low weight. The ceramic element is highly porous and has porosity that may be significantly greater than 50 percent porosity. Large pores in the ceramic element or substrate are often preferably to decrease the overall filter pressure drop.

The present invention provides a filter apparatus for filtering air or gas containing particles, including a porous substrate, the porous substrate made of a porous ceramic material; and a filtering material connected to the porous substrate, the filtering material including nanofibers; wherein the air or gas travels through the porous substrate and travels through the filtering material, wherein the particles are captured in the filtering material. The capture of particles by mechanisms known to those knowledgeable in the art of particulate filtration. The present invention also provides a method of filtering air or gas containing particles, including the steps of providing a porous substrate made of a porous ceramic material; providing a filtering material connected to the porous substrate wherein the filtering material includes nanofibers; and directing the air or gas through the porous substrate and through the filtering material wherein the particles are captured in the filtering material.

The present invention has use in a number of industries including biotech, pharmaceutical manufacturing, clean coal power generation, hazardous materials processing, metals processing, wastewater treatment, semiconductor fabrication, nuclear power generation, radiological facilities, aerospace, defense industries, and petroleum processing.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIGS. 1A, 1B, and 1C illustrate embodiments of the present invention.

FIG. 2 illustrates one embodiment of an electrospinning system for producing an improved air filter.

FIG. 3 shows a matt of nano-fiber material in greater detail.

FIGS. 4A and 4B show additional details of the matt of nano-fiber shown in FIG. 3.

FIG. 5 is a flow chart illustrates a vacuum bath system for producing an improved air filter.

FIG. 6 is an illustration of a filter produced by the vacuum bath system shown in FIG. 5.

FIG. 7 is a flow chart illustrates a diffusion bonding system for producing an improved air filter.

FIG. 8 is a flow chart illustrating a system using physical attachments for producing an improved air filter.

FIG. 9 is an illustration of a filter produced by the system using physical attachments shown in FIG. 8.

FIG. 10 illustrates another embodiment of a filter unit of the present invention that includes a filter unit body and a series of tubular filter elements in the filter unit body.

FIGS. 11A and 11B show two embodiments of flow through tubular filter elements.

FIGS. 12A through 12F show various embodiments of flow through tubular filter elements.

FIG. 13 illustrates an embodiment of filter having filter media contained in a filter unit body.

FIG. 14 illustrates an embodiment of filter having filter media on a porous ceramic substrate.

FIG. 15 is a flow chart illustrating a system for producing a multilayer filter.

FIGS. 16A and 16B illustrate a system for producing a multilayer filter.

FIG. 17 shows the multilayer filter produce by the system of FIGS. 16A and 16B.

FIG. 18 is a flow chart illustrating a system for providing a filter material on a tubular filter element.

### DETAILED DESCRIPTION OF SPECIFIC EMBODIMENTS

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

The present invention includes both the application and the use of nanofibers in relation to ceramic filters. The nanofibers are supported by ceramic elements and/or substrates providing better physical properties (e.g., strength). The ceramic elements are selected for desired filtration-related properties, e.g., high porosity (low pressure drop, high flow rate, and low weight) as well as other physical and chemical properties that may be beneficial to an application (e.g., corrosion resistance, temperature resistance, fire resistance). The porous ceramic material provides a ceramic element of high porosity producing low pressure drop and is of low weight. The ceramic element is highly porous and has porosity that may be significantly greater than 50 percent porosity.

The nanofiber may be located immediately on the ceramic element/substrate, or located on another coating on the ceramic element/substrate. Nanofibers improve the filtration efficiency of ceramic element/substrates as well as coatings. With regards to particulate capture, the filter materials including nanofibers may function by mechanisms including interception, impact, diffusion, and sieving which will be known to those knowledgeable in the art of particle filtration. Inorganic or ceramic nanofibers have particular benefit for corrosive or high temperature filtration applications. Polymer and metal nanofibers may also be deposited on to porous ceramic substrates for some filtration applications. Polymer nanofibers are known to be deposited directly from solutions. Metal nanofibers for example may be created by treatment of metal organic precursor polymers in a reducing environment. Filtration applications that benefit from the use of various types of metal, inorganic (ceramic), and polymer nanofibers are therefore possible with this invention. The present invention has use in a number of industries including biotech, pharmaceutical manufacturing, clean coal power generation, hazardous materials processing, metals processing, wastewater treatment, semiconductor fabrication, nuclear power generation, radiological facilities, aerospace, defense industries, and petroleum processing.

The application of the nanofibers to the ceramic elements and/or substrates is described by a number of examples. In one example electrospinning of nanofibers is used as a secondary layer/coating (e.g., directly on a ceramic element/substrate or on another filtering material) or (bypassing the need for a ceramic element/substrate) as the primary filter layer. In another example a vacuum bath process is used to apply nanofibers and related materials to a ceramic element. In another example, the nanofibers are applied by using diffusion bonding or by using a binder(s) and/or physical attachments such as metal wire wraps. The ceramic element or substrate may include glass, silica, or amorphous or crystalline forms of inorganic ceramic materials including aluminum oxide, zirconium oxide, mullite, and other oxides and potentially non-oxide such as silicon carbide and molybdenum disilicide or other materials that will be known to those knowledgeable in the field of inorganic materials.

In one embodiment, the present invention provides a ceramic HEPA filter designed to meet commercial and U.S. Department of Energy (DOE) requirements, as well as to minimize upgrade installation logistics for use in existing facilities. Current key performance requirements are described in DOE Standard 3020. The ceramic filter is designed to be nonflammable, corrosion resistant, and compatible with high temperatures and moisture. The ceramic filter will significantly increase filter life span and reduce life cycle costs, and open up new opportunities for overall process gas system and ventilation system design. Advantages include: specialty application processes could be significantly improved by a ceramic HEPA filter with nuclear and biological performance characteristics exceeding that of traditional, non-ceramic filters, ceramic HEPA filter will minimize retrofit problems and costs while meeting requirements, industries utilizing fume hoods and glove boxes can benefit from a nonflammable, corrosion resistant ceramic filter, replacement of existing filters with more durable versions with enhanced capabilities and open up industrial avenues closed by current technology and regulations. Performance against chemical threats would mostly likely be limited to applications where the nanofiber material could be selected to be reactive with a chemical species in limited concentrations and employ benefit from a high surface area of the nanofibers. Large quantity of nanofiber in the filter may be required which would potentially impact the pressure drop of the filter. Features of this filter invention include: moisture resistant, longer lifespan, more durable, nonflammable, and more corrosion resistant filters and filter material. Benefits include: increased safety of operations, minimized contamination issues, longer operational life of filters, longer shelf life of filters, minimized operational downtime due to maintenance outages, fewer interruptions in the manufacturing process, lower life cycle costs, lower support system and regulatory compliance costs, lower waste disposal costs, increased capability of handling higher temperatures and higher pressures, more resistance to chemical attack, and more resistance to fire.

Ceramic HEPA filters open the doors for new applications of HEPA filtration in numerous industries, such as biotechnology. Nuclear reactors, radiological facilities and other hazardous material processing facilities that encounter non-trivial contamination issues and life cycle costs (both operational and waste disposal) for filters and affiliated support systems.

### Example 1

### Electrospinning

In one embodiment the present invention uses electrospinning of nanofibers to produce a filter material and a filter. The filter material can be used as a secondary layer/coating (e.g., directly on a ceramic element/substrate or on another filtering material) or (bypassing the need for a ceramic element/substrate) as the primary filter layer.

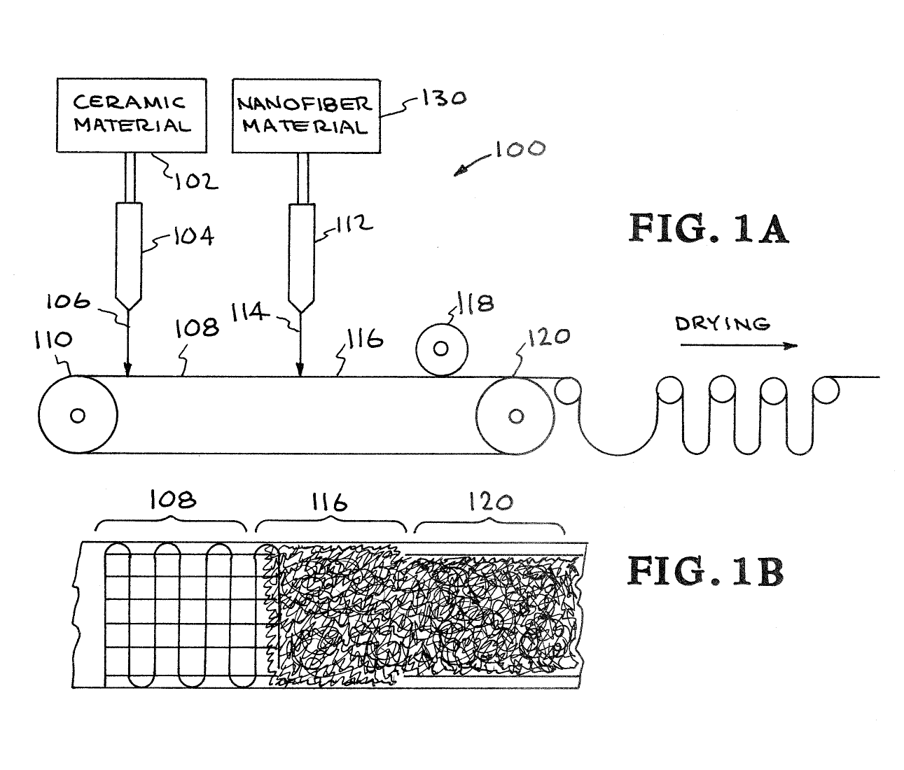

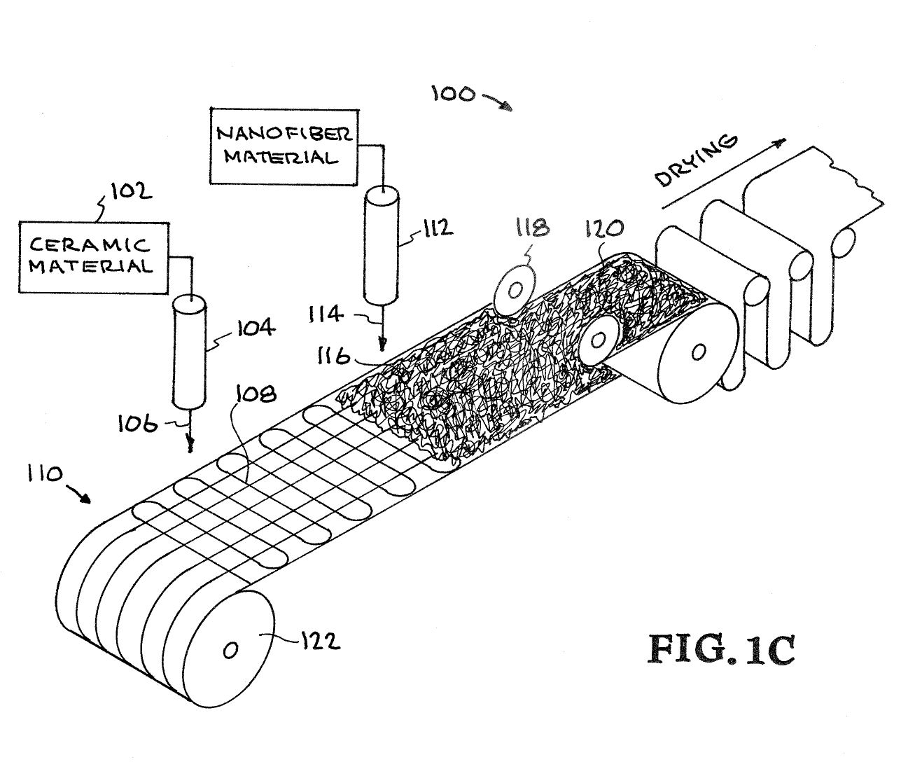

Referring now to the drawings and in particular to FIGS. 1A, 1B, and 1C, embodiments of systems of electrospinning of nanofibers to produce a filter material and a filter are shown. The systems are designated generally by the reference numeral 100. One system 100 for electrospinning of nanofibers to produce a filter material and a filter is shown in FIG. 1A. A rotational conveyer 110 provides translational and rotational movement. An extruder 104 receives ceramic material 102 and extrudes a stream 106 of the ceramic material 102 on to a conveyer 110 to produce a ceramic substrate 108. The rotational conveyer 110 turns to allow the ceramic material 102 to spread across a swath and form the ceramic substrate 108. The ceramic material 102 that forms the ceramic substrate 108 is selected for high porosity to provide low pressure drop and low weight. The swath of ceramic material 102 is shown in FIG. 1B.

An electrospinning unit 112 contains a nanofiber material 130 and electrospins a jet 114 of the nanofiber material 116 onto the ceramic substrate 108 on the conveyer 110 to produce the nanofiber filter material 120. The rotational conveyer 110 turns to allow the jet 114 of the nanofiber material 116 to spread and form a swath of nanofiber filter material 120. Both the extruder 104 and the electrospinning unit 112 may be translated or moved as needed to produce uniform coverage of the conveyor 110. The swath of nanofiber filter material 120 is shown in FIG. 1B. Note that in FIG. 1B the nanofiber filter material 116 is deposited on the ceramic substrate 108 and multilayers of the nanofiber filter material 116 forms the nanofiber filter material 120. The nanofiber filter material 120 may be further secured to the ceramic substrate by sintering or by use of an inorganic bonding agent or organic binder. Alternative approaches appropriate to metals and polymers may be used to complete the processing of polymer and metal nanofiber filtration materials

The ceramic substrate 108, layer of nano-fiber material 116, and the matt of trimmed filter material 120 are shown in greater detail in FIG. 1B. The system uses the extruder of ceramic material to extrude a stream of the ceramic material to produce the ceramic substrate 108. The ceramic substrate 108 is a woven substrate of ceramic material that has high porosity (low pressure drop and low weight). The porous ceramic material provides a ceramic element of high porosity producing low pressure drop and is of low weight. The ceramic element is highly porous and has porosity significantly greater than 50 percent porosity.

The system for electrospinning uses electrospinning technology to form the matt 120 of nan-fibers on the ceramic substrate 108. The nozzle produces a jet of sol-gel solution of nanofibers onto the ceramic substrate 108 wherein the matt 120 of nano-fiber material is produced on the ceramic substrate 108. The ceramic substrate 108 forms the base for the matt 116. The trimmer 118 cuts the sides of the substrate 108 to form the filter material 120.

Another system 100 for electrospinning of nanofibers to produce a filter material and a filter is shown in FIG. 1C. A conveyer 110 provides translational movement of nano-fiber support base from a prepared roll 122. An extruder 104 receives ceramic material 102 and extrudes a stream 106 of the ceramic material 102 onto material from the prepared roll 122 to produce a ceramic substrate 108. The ceramic material 102 that forms the ceramic substrate 108 is selected for high porosity to provide low pressure drop and low weight. In other embodiments the prepared roll 122 contains a finished ceramic substrate and the subsequent electrospinning operations are performed on the finished substrate. Alternatively, the finished substrate can be provided by other means than the prepared roll 122 such as sequential ceramic plates or ceramic plates connected by a flexible connections.

An electrospinning unit 112 contains a nanofiber material and electrospins a jet 114 of the nanofiber material 116 onto the ceramic substrate 108 on the conveyer 110 to produce the nanofiber filter material 120. The conveyer 110 results in the jet 114 of the nanofiber material 116 forming a swath of nanofiber filter material 120. The swath of nanofiber filter material 120 is deposited on the ceramic substrate 108 and multilayers of the nanofiber filter material 116 form the nanofiber filter material 120. The nanofiber filter material 120 may be further secured to the ceramic substrate by sintering or by use of an inorganic bonding agent. Other methods of producing or utilizing a ceramic substrate in this example will be obvious to those knowledgeable in ceramic processing including substrates obtained by tape casting, foaming and drying of ceramic slurries, or other processes. Prefabricated porous ceramic plates that may be produced by a variety of methods also may be used in a semi-continuous fashion.

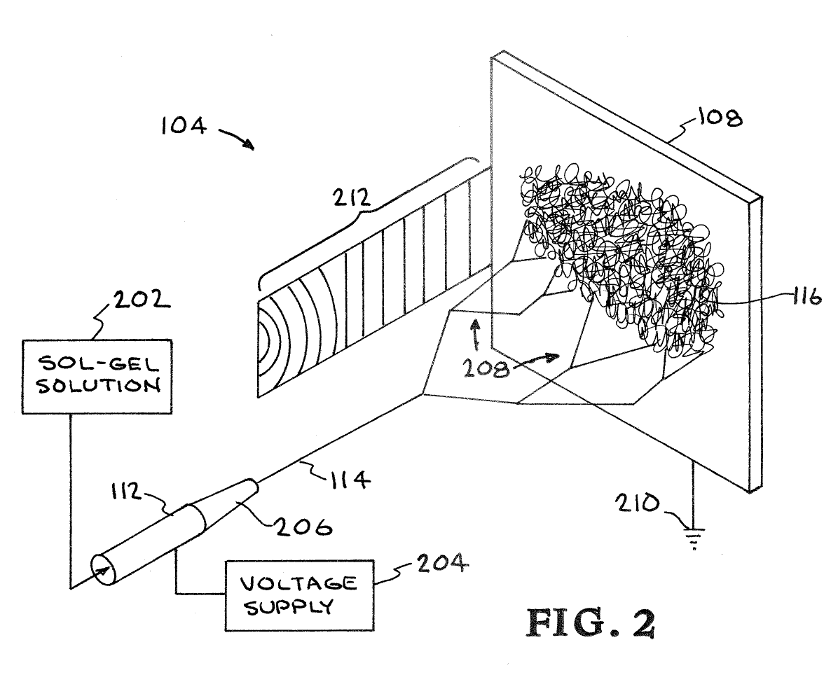

Referring now to FIG. 2, the electrospinning unit 104 is shown in greater detail. The electrospinning unit 104 uses electrospinning technology to form a matt 116 of nanofibers. A supply of sol-gel solution of nanofibers 202 is fed to an electrospinning unit 112 having a nozzle 112 where the sol-gel solution of nanofibers is ejected as a jet 114. A voltage source 204 provides a voltage supply to the electrospinning unit 112. The jet of sol-gel solution of nanofibers is directed toward the ceramic substrate 108. The ceramic substrate acts as an electrically conductive collector through appropriate electrical connections 210. Alternatively a ground plate connected to electrical connection 210 may be placed beneath the ceramic substrate to imposed the needed electrical field. The voltage source 204 and the electrical connections 210 create a constant electrical potential between the nozzle 206 and the ceramic substrate 108. Preferably, in this example nozzle 206 would be an electrically conducting material and connected to the voltage supply 204. As the jet 114 enters the electrical field 212 it splays out (spinning) and is deposited on the ceramic substrate 108. Alternatively, it is known that electrospinning of fibers can be accomplished without splaying in depositing a single fiber and consequently splaying although potentially desirable is not required for the production of nanofibers. The splaying is illustrated at 208. The matt 116 of nanofiber material is produced on the ceramic substrate 108.

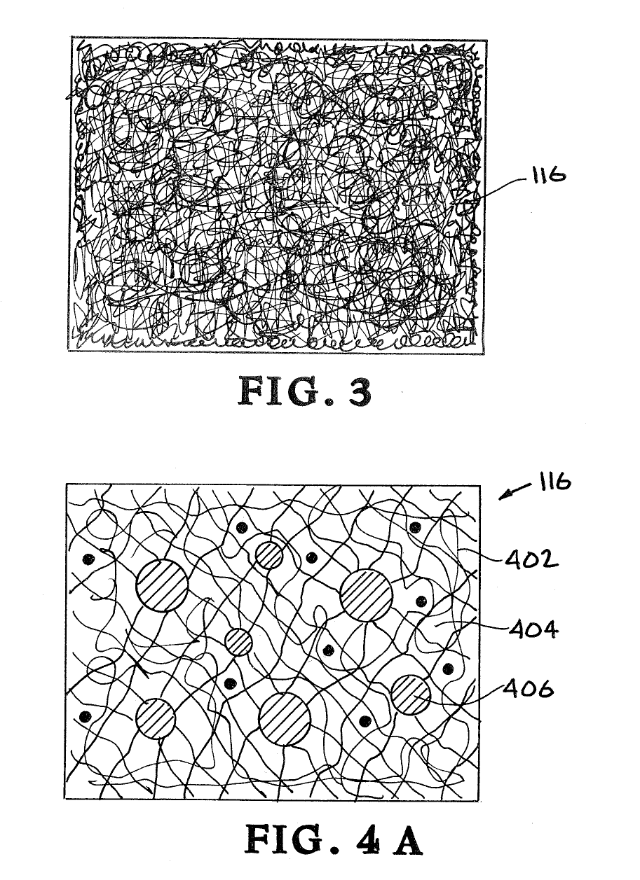

The matt 116 of nanofiber material on the ceramic substrate 108 is shown in greater detail in FIG. 3. The ceramic substrate 108 that forms the base for the filter is made of a ceramic that is selected for high porosity to provide low pressure drop and low weight. The nanofibers that form the matt 116 improve the filtration efficiency of the ceramic element/substrate as well as functioning as a coating layer made using the matt 116. In one embodiment the matt 116 has a filter material that are nanofibers with a diameter that is within the range of one nanometer to two hundred nanometers. In one embodiment the matt 116 has a filter material that are nanofibers with a diameter that is within the range of five nanometers to two hundred nanometers. In one embodiment the matt 116 has a filter material that are nanofibers with a diameter that is within the range of five nanometers to two hundred nanometers and wherein some of said nanofibers in said filtering material have a diameter that is larger than two hundred nanometers.

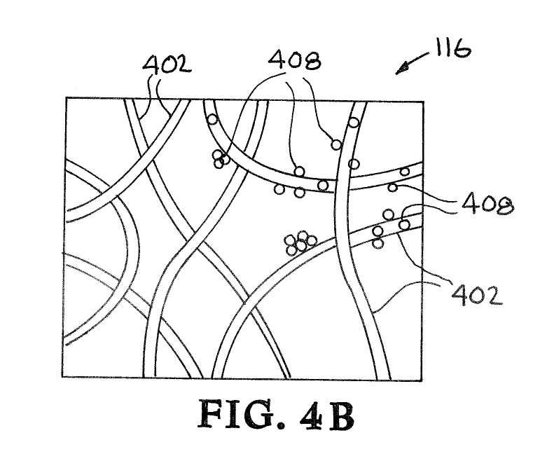

Additional details of the matt 116 of nano-fiber are shown in FIGS. 4A and 4B. An enlarged portion of the matt 116 of nano-fiber of FIG. 3 is shown in FIG. 4A. The matt 116 is made of individual fibers 402. The individual fibers 402 provide a fine web that has open areas 404 made up of the three dimensional web of fibers 402. The particles 406 being filtered become trapped in contact with the fibers 402. In one embodiment the matt 116 has a filter material that are ceramic nanofibers. In one embodiment the matt 116 has a filter material that are nanofibers with a diameter that is within the range of one nanometer to two hundred nanometers. In one embodiment the matt 116 has a filter material that are nanofibers with a diameter that is within the range of five nanometers to two hundred nanometers. In one embodiment the matt 116 has a filter material that are nanofibers with a diameter that is within the range of five nanometers to two hundred nanometers and wherein some of said nanofibers in said filtering material have a diameter that is larger than two hundred nanometers.

An enlarged portion of the matt 116 of nano-fiber of FIG. 4A is shown in FIG. 4B. The matt 116 is made of individual fibers 402. The individual fibers 402 provide a fine web. The particles 408 that are smaller than the particles 406 shown in FIG. 3 become trapped in contact with the fibers 402. The filter produce by the matt 116 of nano-fiber material has many advantages over prior art filters. These advantages include embodiments wherein the ceramic substrate 108 that forms the base for the filter and the nanofibers that form the matt 116 provide low pressure drop. In one embodiment the porous ceramic material of said porous substrate and the filtering material including nanofibers have structures that produce a pressure drop in the fluid that travels through said porous substrate and travels through said filtering material and said pressure drop is within the range of two to six inches of water column pressure drop. In another embodiment the porous ceramic material of said porous substrate and the filtering material including nanofibers have structures that produce a pressure drop in the fluid that travels through said porous substrate and travels through said filtering material and said pressure drop is within the range of six to ten inches of water column pressure drop. In yet another embodiment the porous ceramic material of said porous substrate and the filtering material including nanofibers have structures that produce a pressure drop in the fluid that travels through said porous substrate and travels through said filtering material and said pressure drop is greater than ten inches of water column pressure drop. These advantages include embodiments that provide a filter having an efficiency of 99.97% for 0.3 micron DOP particles with low pressure drop in a form that can be resistant to high temperatures, corrosive environments, and have other advantages previously described. These advantages include other embodiments that provide filters for other filtration levels such as ultrafiltration and sub-HEPA filtration. Table 1 below provides examples of other filtration levels that are achieved by filters of the present invention.

TABLE 1
European Normalisation standards filter classes

| | | | | Particulate | |
|---|---|---|---|---|---|
| | | | | size | |
| | | | Per- | approaching | |
| | | | formance | 100% | Test |
| Usage | Class | Performance | test | retention | Standard |
| Primary | G1 | 65% | Average | >5 μm | BS EN779 |
| filters | | | value | | |
| | G2 | 65-80% | Average | >5 μm | BS EN779 |
| | | | value | | |
| | G3 | 80-90% | Average | >5 μm | BS EN779 |
| | | | value | | |
| | G4 | 90%- | Average | >5 μm | BS EN779 |
| | | | value | | |
| Secondary | F5 | 40-60% | Average | >5 μm | BS EN779 |
| filters | | | value | | |
| | F6 | 60-80% | Average | >2 μm | BS EN779 |
| | | | value | | |
| | F7 | 80-90% | Average | >2 μm | BS EN779 |
| | | | value | | |
| | F8 | 90-95% | Average | >1 μm | BS EN779 |
| | | | value | | |
| | F9 | 95%- | Average | >1 μm | BS EN779 |
| | | | value | | |
| Semi | H10 | 85% | Minimum | >1 μm | BS EN1822 |
| Hepa | | | value | | |
| | H11 | 95% | Minimum | >0.5 μm | BS EN1822 |
| | | | value | | |
| | H12 | 99.5% | Minimum | >0.5 μm | BS EN1822 |
| | | | value | | |
| Hepa | H13 | 99.95% | Minimum | >0.3 μm | BS EN1822 |
| | | | value | | |
| | H14 | 99.995% | Minimum | >0.3 μm | BS EN1822 |
| | | | value | | |

### Example 2

### Vacuum Bath Process

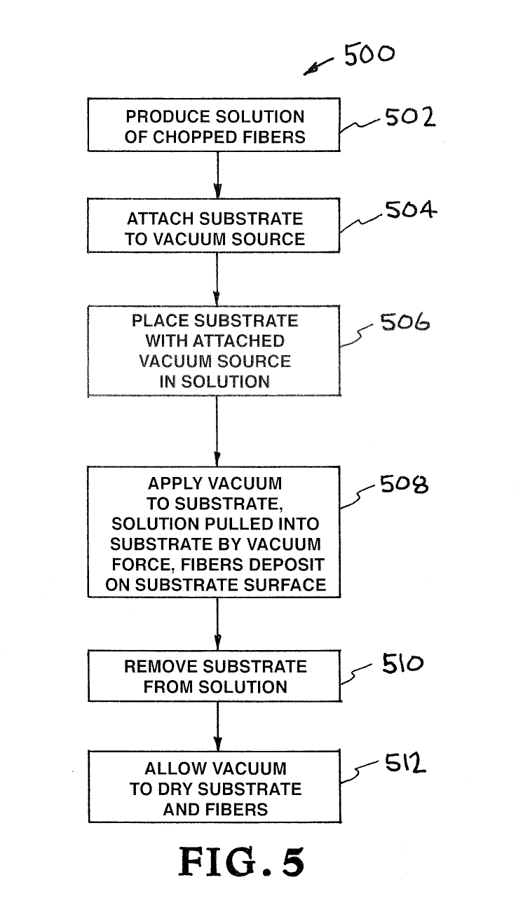

In another embodiment, the present invention uses a vacuum bath process to produce a filter material and a filter. The filter material can be used as a secondary layer/coating (e.g., directly on a ceramic element/substrate or on another filtering material) or (bypassing the need for a ceramic element/substrate) as the primary filter layer. In the latter case, a porous mandrel will need to be used and the filter material will need to be removed from the porous mandrel. FIG. 5 is a flow chart illustrating a vacuum bath process used to apply nanofibers and related materials to a ceramic element. The vacuum bath process is designated generally by the reference numeral 500.

In step one (502) of the vacuum bath process 500, a solution of chopped nanofibers is produced. This step could also include a mixture of nanofibers and significantly larger fibers or just the larger fibers depending on the filtration requirements for a given use of the invention. In step 2 (504) the porous ceramic substrate is attached to a vacuum source. In step 3 (506) the porous ceramic substrate with the attached vacuum source is placed in the solution of the chopped nanofibers. In step 4 (508) a vacuum is applied to the substrate and the solution of chopped fibers is pulled into the substrate by the vacuum. The fibers are deposited in the substrate. In step 5 (510) the substrate is removed from the solution. In step 6 (512) the substrate is vacuum dried. Step 6 may be optional and other methods can be used to dry the substrate and fibers if desired.

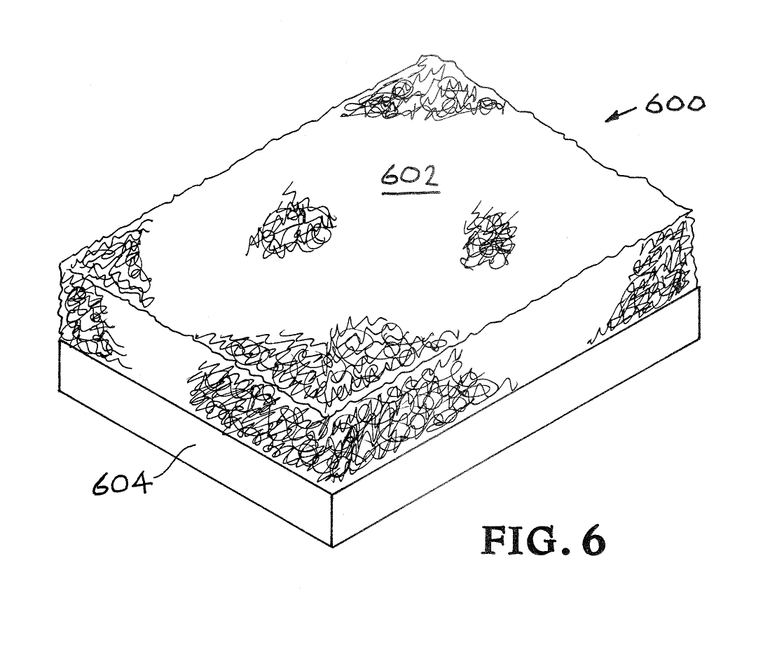

Referring now to FIG. 6 a filter that has been produced by the vacuum bath process is illustrated. The filter is designated generally by the reference numeral 600. The filter 600 includes a porous ceramic substrate 602 and a matt 604 of nanofibers (or other chopped fibers as described earlier) on the substrate 602.

### Example 3

### Diffusion Bonding Process

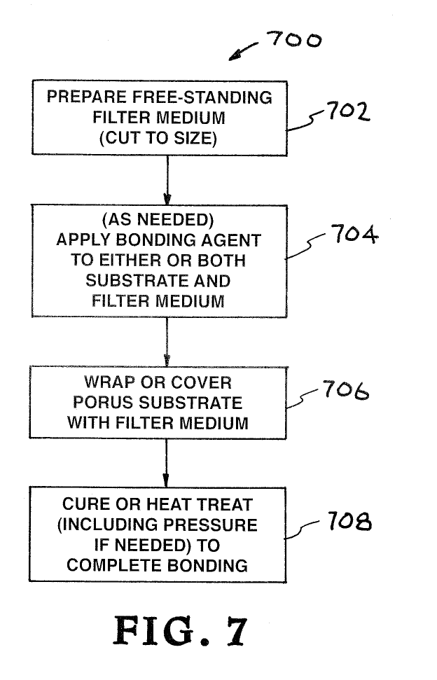

In another embodiment, the present invention uses a diffusion bonding process to produce a filter material and a filter. The filter material can be used as a secondary layer/coating (e.g., directly on a ceramic element/substrate or on another filtering material) or (bypassing the need for a ceramic element/substrate) as the primary filter layer. FIG. 7 is a flow chart illustrating a diffusion bonding the process used to apply nanofibers to a ceramic element. The diffusion bonding process is designated generally by the reference numeral 700.

In step one (702) of the diffusion bonding process 700, a free-standing filter medium is cut to size. In step 2 (704) a bonding agent is applied to the free-standing filter medium. In step 3 (706) the free-standing filter medium is wrapped or positioned to cover the porous ceramic substrate. In step 4 (708) the free-standing filter medium with the bonding agent is cured by heating and if necessary with pressure to complete the bonding of the free-standing filter medium to the porous ceramic substrate.

### Example 4

### Physical Attachments Process

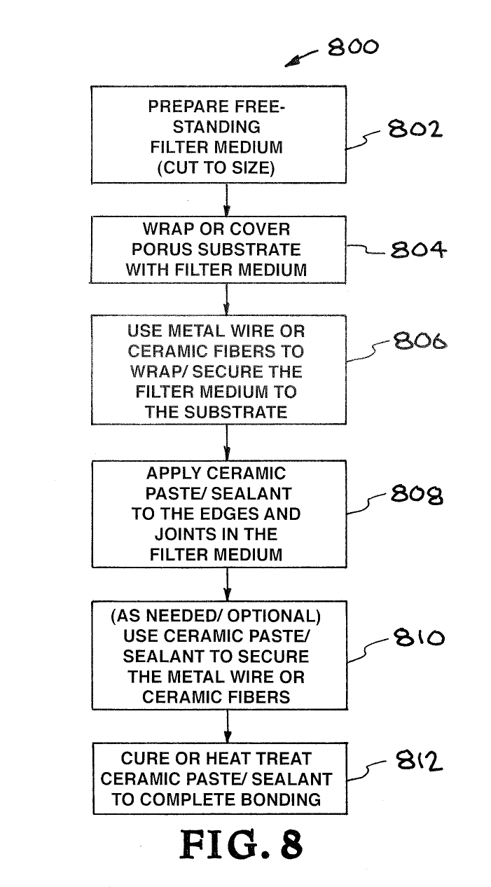

In another embodiment, the present invention uses a binder(s) and/or physical attachments process to produce a filter. FIG. 8 is a flow chart illustrating a binder(s) and/or physical attachments process used to apply nanofibers or other prepared fiber filtration medium to a ceramic element. The binder(s) and/or physical attachments is designated generally by the reference numeral 800.

In step one (802) of the binder(s) and/or physical attachments process 800, a free-standing filter medium is cut to size and optionally binder is applied to bottom surface. In step 2 (804) the free-standing filter medium is wrapped or positioned to cover the porous ceramic substrate. In step 3 (806) metal wire or ceramic fiber(s) are used to wrap and secure the filter medium to the porous ceramic substrate. In step 4 (808) a ceramic paste/sealant is applied to the edges and joints in the filter medium to seal against leaks at edges of the filter medium. In step 5 (810) a ceramic paste/sealant is applied to the metal wire or ceramic fibers. In step 6 (812), if bonding agents were used, the filter medium with the bonding agent is cured by to complete the bonding.

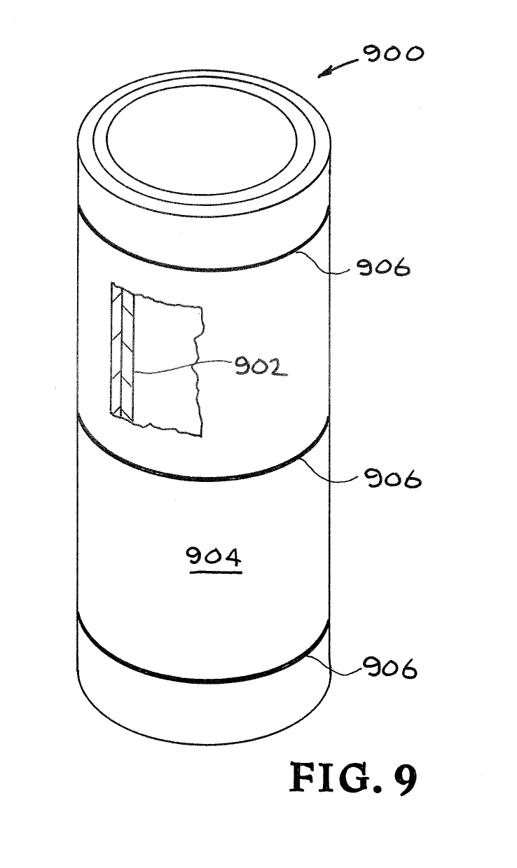

Referring now to FIG. 9 a filter that has been produced by the binder(s) and/or physical attachments process is illustrated. The filter is designated generally by the reference numeral 900. The filter 900 includes a porous ceramic substrate 902 and a matt 904 of the filter medium on the substrate. A free-standing filter medium 904 has been cut to size. The free-standing filter medium 904 has been wrapped or positioned to cover the porous ceramic substrate 902. Metal wire or ceramic fibers 906 are used to wrap and secure the filter medium 904 to the porous ceramic substrate 902. Alternatively, the wire or fiber(s) 906 could be wrapped in a spiral form (or in other fashions) from one end of tube 902 to the other end. A ceramic paste/sealant has been applied to the edges and joints in the filter medium 904. Also, a ceramic paste/sealant has been applied to the metal wire or ceramic fibers 906 if needed to secure the wire or fibers

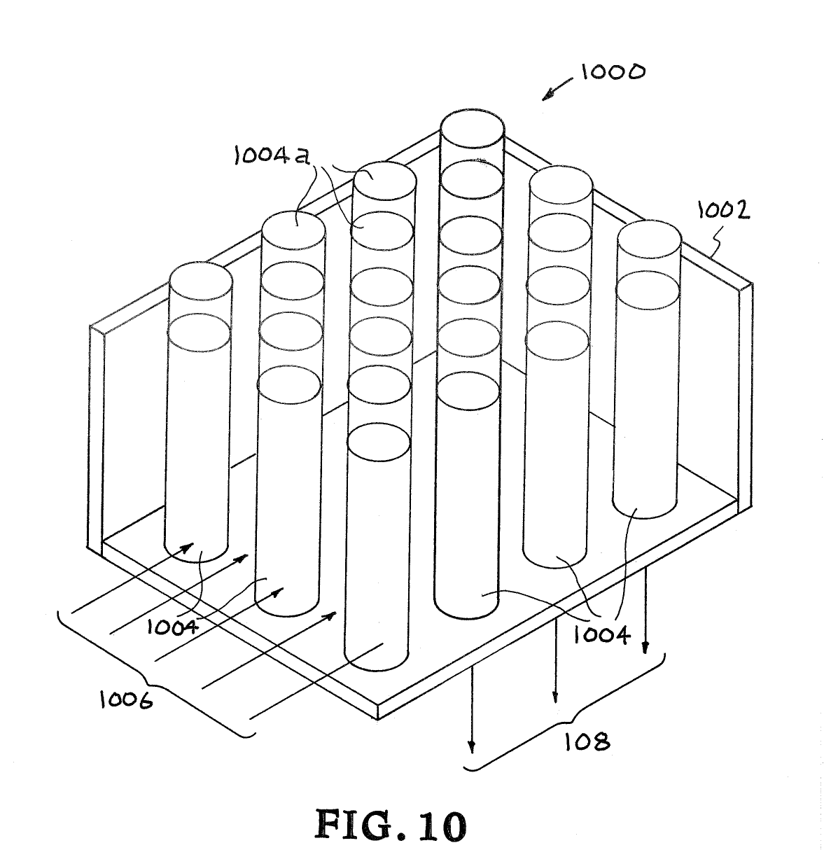

Referring now to the drawings and in particular to FIG. 10, one embodiment of a filter unit of the present invention is illustrated. The filter unit is designated generally by the reference numeral 1000. The filter unit 1000 includes a filter unit body 1002. A series of tubular filter elements 1004 are contained in the filter unit body 1002. The tubular filter elements 1004 are closed at the top and open at the bottom. The tubular filter elements 1004 are closed at the top as illustrated by the closed tops 1004a. The fluid to be “filtered in: is illustrated by the arrow 1006 and the fluid to be “filtered out” is illustrated by the arrow 1008. The fluid (gas) being filtered passes through a filter material connected to the tubular filter elements 1004.

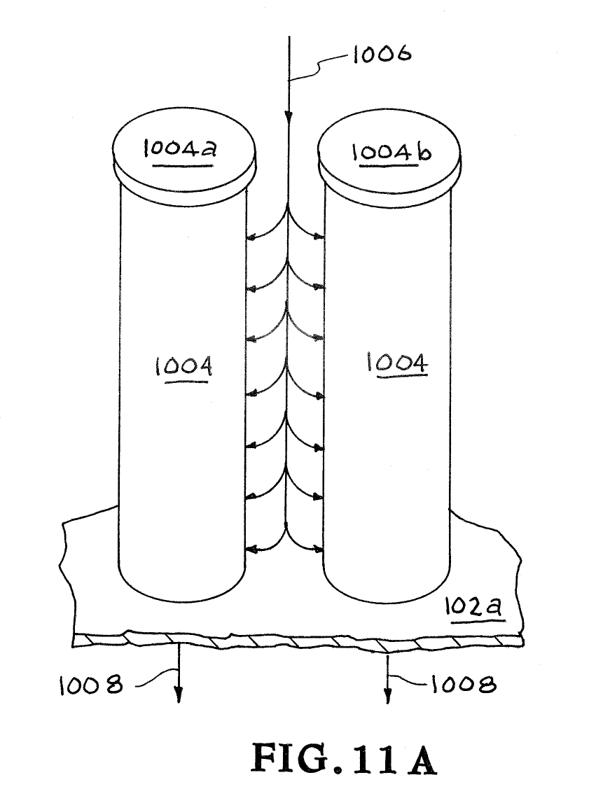

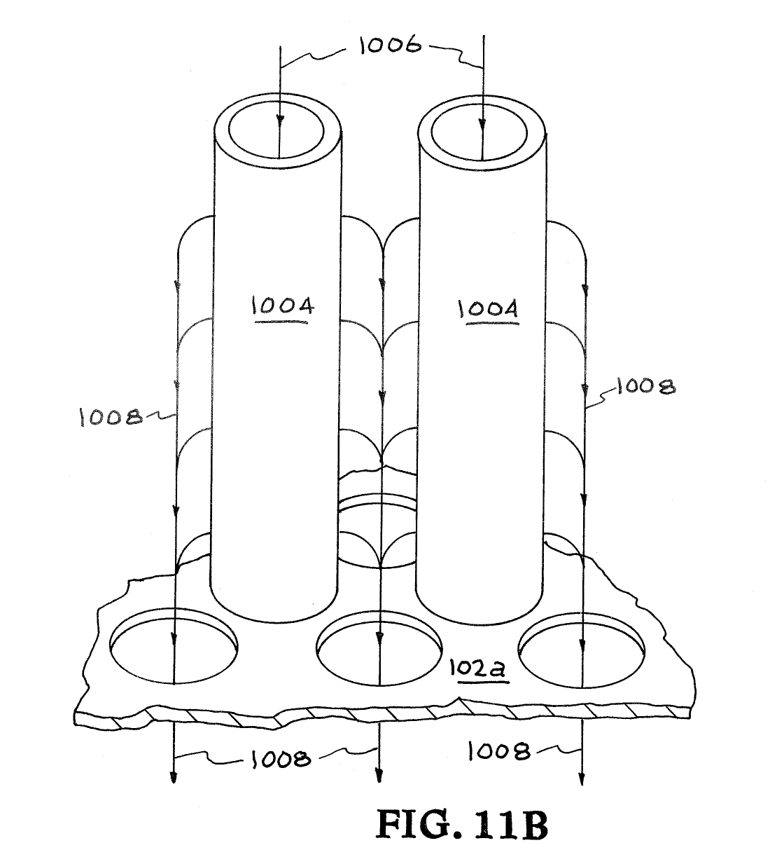

Referring now to FIGS. 11A and 11B, a pair of the tubular filter elements 1004 of the filter unit 1000 of FIG. 10 are illustrated. The tubular filter elements 1004 are contained in the filter unit body and mounted on a base plate 1002a.

FIG. 11A shows an embodiment wherein and the tubular filter elements 1004 are closed at the top as illustrated by the closed tops 1004a. The tubular filter elements 1004 are open at the bottom allowing the flow of the fluid being filter out. The fluid to be “filtered in” is illustrated by the arrow 1006 and the fluid to be “filtered out” is illustrated by the arrows 1008. The fluid being filtered passes through the filter material connected to the tubular filter elements 1004.

FIG. 11B shows an embodiment wherein and the tubular filter elements 1004 are open at the top. The tubular filter elements 1004 are closed at the bottom forcing the fluid being filtered to pass through the filter material on the tubular filter elements 1004. The fluid to be “filtered in” is illustrated by the arrow 1006 and the fluid to be “filtered out” is illustrated by the arrows 1008. The fluid being filtered passes through the filter material connected to the tubular filter elements 1004.

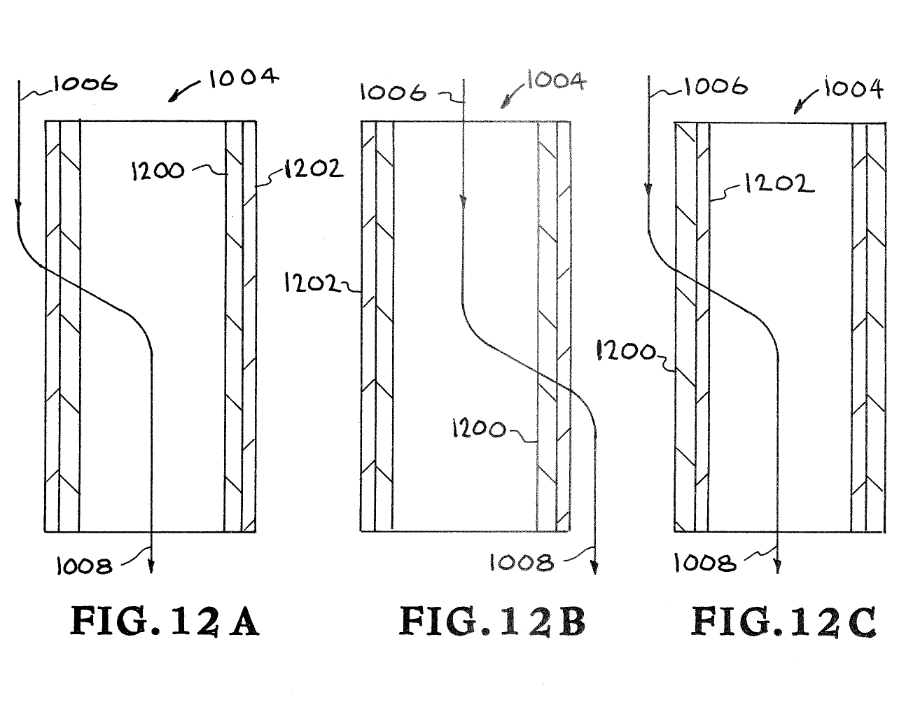

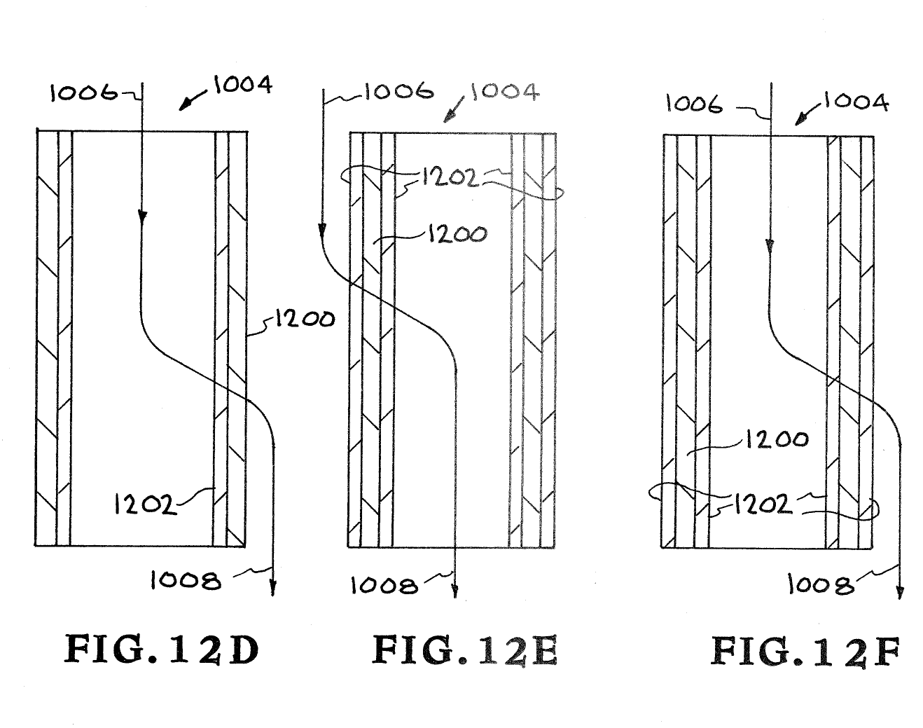

Referring now to FIGS. 12A through 12F, a series of the tubular filter elements 1004 of the filter unit 1000 of FIG. 10 and FIG. 2 are illustrated. FIGS. 12A through 12F illustrate a number of the flow patterns of the fluid being filtered passing through the filter material connected to the tubular filter elements 1004. In some of the illustrations the tubular filter elements 1004 are closed at the top and are open at the bottom allowing the flow of the fluid being filtered through the tubular filter elements 1004. In other of the illustrations the tubular filter elements 1004 are open at the top and are closed at the bottom allowing the flow of the fluid being filtered through the tubular filter elements 1004. In all instances the fluid being filtered passes through the filter material connected to the tubular filter elements 1004. FIGS. 12A through 12F illustrate a number of the flow patterns of the fluid being filtered passing through the filter material connected to the tubular filter elements 1004.

Referring now to FIG. 12A, an illustration of one version of the flow pattern of the fluid being filtered passing through the filter material connected to the tubular filter elements 1004 is shown. The filter material 1202 is located on the outside of the substrate 1200 that forms the tubular filter element 1004. The tubular filter element 1004 is closed at the top and is open at the bottom allowing the flow of the fluid being filter from the outside through the tubular filter element 1004 into the center of the tubular element 1004 and out the bottom.

Referring now to FIG. 12B, an illustration of another version of the flow pattern of the fluid being filtered passing through the filter material connected to the tubular filter elements 1004 is shown. The filter material 1202 is located on the outside of the substrate 1200 that forms the tubular filter element 1004. The tubular filter element 1004 is open at the top and is closed at the bottom allowing the flow of the fluid being filter from the inside through the tubular filter element 1004 to the outside of the tubular element 1004.

Referring now to FIG. 12C, an illustration of another version of the flow pattern of the fluid being filtered passing through the filter material connected to the tubular filter elements 1004 is shown. The filter material 1202 is located on the inside of the substrate 1200 that forms the tubular filter element 1004. The tubular filter element 1004 is closed at the top and is open at the bottom allowing the flow of the fluid being filtered from the outside through the tubular filter element 1004 into the center of the tubular element 1004 and out the bottom.

Referring now to FIG. 12D, an illustration of another version of the flow pattern of the fluid being filtered passing through the filter material connected to the tubular filter elements 1004 is shown. The filter material 1202 is located on the inside of the substrate 1200 that forms the tubular filter element 1004. The tubular filter element 1004 is open at the top and is closed at the bottom allowing the flow of the fluid being filtered from the inside of the tubular filter element 1004 through the substrate 1200 and the filter material 1202 to the outside of the tubular element 1004.

Referring now to FIG. 12E, an illustration of another version of the flow pattern of the fluid being filtered passing through the filter material connected to the tubular filter elements 1004 is shown. The filter material 1202 is located on both the inside and the outside of the substrate 1200 that forms the tubular filter element 1004. The tubular filter element 1004 is closed at the top and is open at the bottom allowing the flow of the fluid being filter from the outside of the tubular filter element 1004 through the substrate 1200 and the filter material 1202 to the inside of the tubular element 1004 and out the bottom.

Referring now to FIG. 12F, an illustration of another version of the flow pattern of the fluid being filtered passing through the filter material connected to the tubular filter elements 1004 is shown. The filter material 1202 is located on both the inside and the outside of the substrate 1200 that forms the tubular filter element 1004. The tubular filter element 1004 is open at the top and is closed at the bottom allowing the flow of the fluid being filter from the inside of the tubular filter element 1004 through the substrate 1200 and the filter material 1202 to the outside of the tubular element 1004.

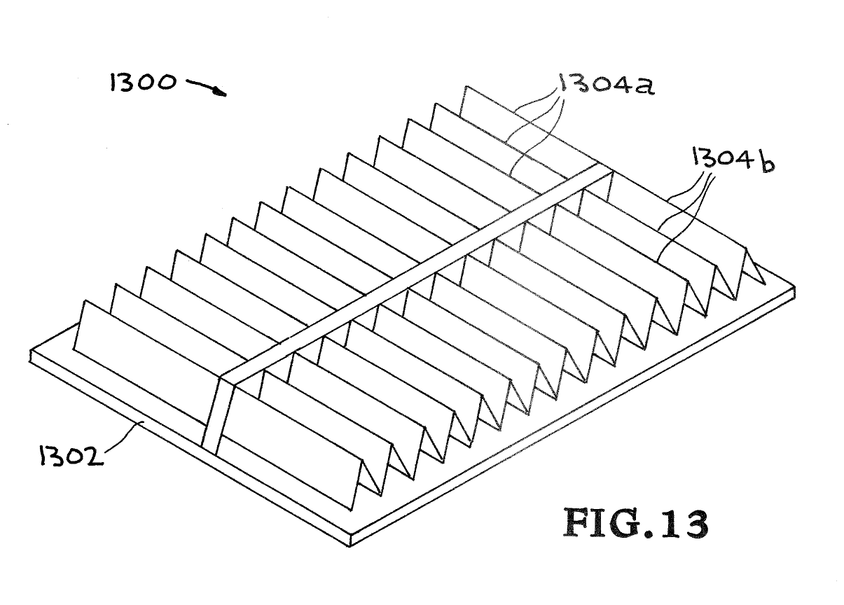

Referring now to FIG. 13, another embodiment of a filter unit of the present invention is illustrated. The filter unit is designated generally by the reference numeral 1300. The filter unit 1300 includes a filter unit body 1302. Filter elements 1304 are contained in the filter unit body 1302.

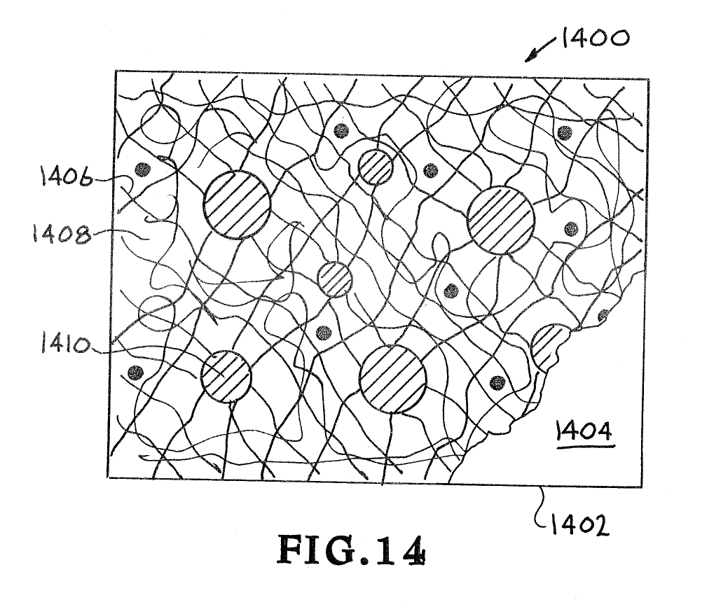

Referring now to FIG. 14 a filter that has been produced by the vacuum bath process is illustrated. The filter is designated generally by the reference numeral 1400. The filter 1400 includes a porous ceramic substrate 1404 and a matt 1402 of nanofibers on the substrate 1404. The matt 1402 is made of individual fibers 1406. The individual fibers 1406 provide a fine web that has open areas 1408 made up of the three dimensional web of fibers 1406. The particles 1410 being filtered become trapped in contact with the fibers 1406. In one embodiment the matt 1402 has a filter material that are ceramic nanofibers. In one embodiment the matt 1402 has a filter material that are nanofibers with a diameter that is within the range of one nanometer to two hundred nanometers. In one embodiment the matt 1402 has a filter material that are nanofibers with a diameter that is within the range of five nanometers to two hundred nanometers. In one embodiment the matt 1402 has a filter material that are nanofibers with a diameter that is within the range of five nanometers to two hundred nanometers and wherein some of said nanofibers in said filtering material have a diameter that is larger than two hundred nanometers. The individual fibers 1406 provide a fine web. The particles 1410 and even smaller particles 1414 become trapped in contact with the fibers 1406. The filter produce by the matt 1402 of nanofiber material has many advantages over prior art filters. These advantages include providing a filter having an efficiency of 99.97% for 0.3 micron DOP particles.

### Example 5

### Multi-Layer Process

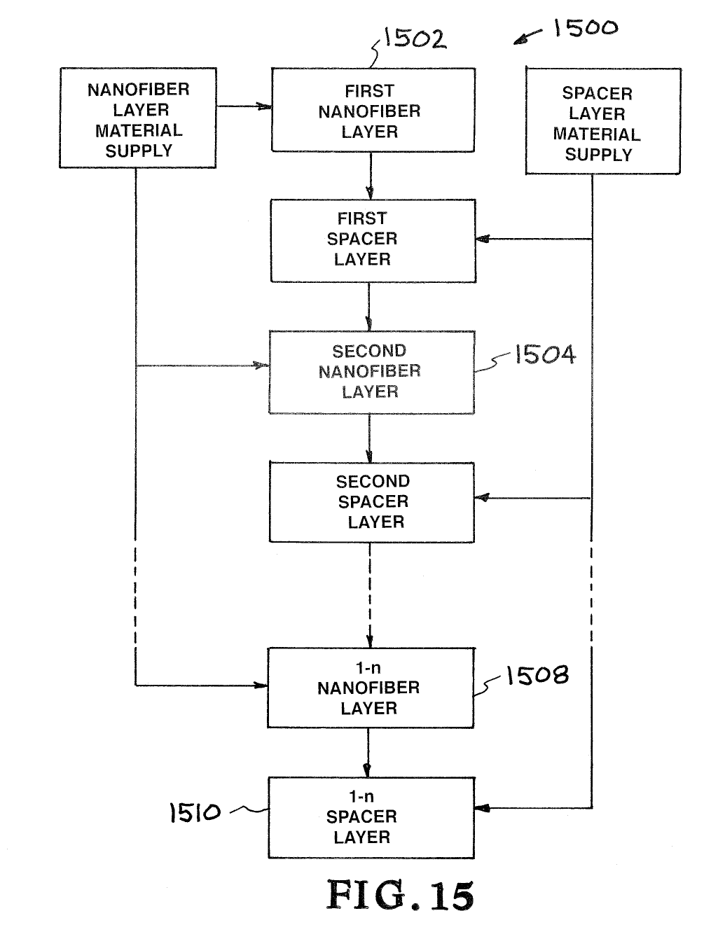

In another embodiment, the present invention uses a multi-layer process to produce a filter material and a filter. The filter material can be used as a secondary layer/coating (e.g., directly on a ceramic element/substrate or on another filtering material) or (bypassing the need for a ceramic element/substrate) as the primary filter layer. FIG. 15 is a flow chart illustrating a multi-layer process used to apply nanofibers and related materials to a ceramic element. The multi-layer process is designated generally by the reference numeral 1500.

In step one (1502) of the multi-layer process filter medium (nanofibers or larger fiber filter medium) is deposited by any of the methods described (electrospinning, vacuum deposition, or others).

In step 2 (1504) a different type of fiber filter medium is deposited over the filter medium deposited in step one (1502). The invention utilizes this different layer to allow the layer of fine fibers such as nanofibers to be sufficiently porous to leave large openings between the fibers when view normal to the plane of the fibers. This layer may conveniently be described as a spacer layer when it provides the purpose described here.

In step 3 (1506) a repeat of step one (1502) or some other fiber layer composition is applied

In step 4 (1508) a repeat of step two (1504) or some other fiber layer composition is applied

In step 5 (1510) again another repeat of step one (1502) or some other fiber layer composition is applied.

This repetition of two or more types of fiber layers can continue as needed for the specific filter application and/or the requirements for particle removal efficiency. In some cases, a preferred implementation of the multi-layered implementation of this invention is co-deposition of for example both fine fibers such as nanofibers along with and at the same time depositing larger fibers (up to and including diameters greater than 1 micrometer). The fibers may both be for example be produced by electrospinning or potentially deposited by creating or blowing chopped fibers by various methods including entraining in a gas flow. Various other alternative deposition techniques may include dispersing large chopped fibers in a solution which solution is sprayed or atomized to cause deposition of the fibers. Methods of dispersion and deposition may be those that are known to those knowledgeable in the art of ceramic processing. The large fibers may beneficially include chopped large fibers with aspect ratios of the length to diameter as low as 1:1 and up to 200:1 or larger.

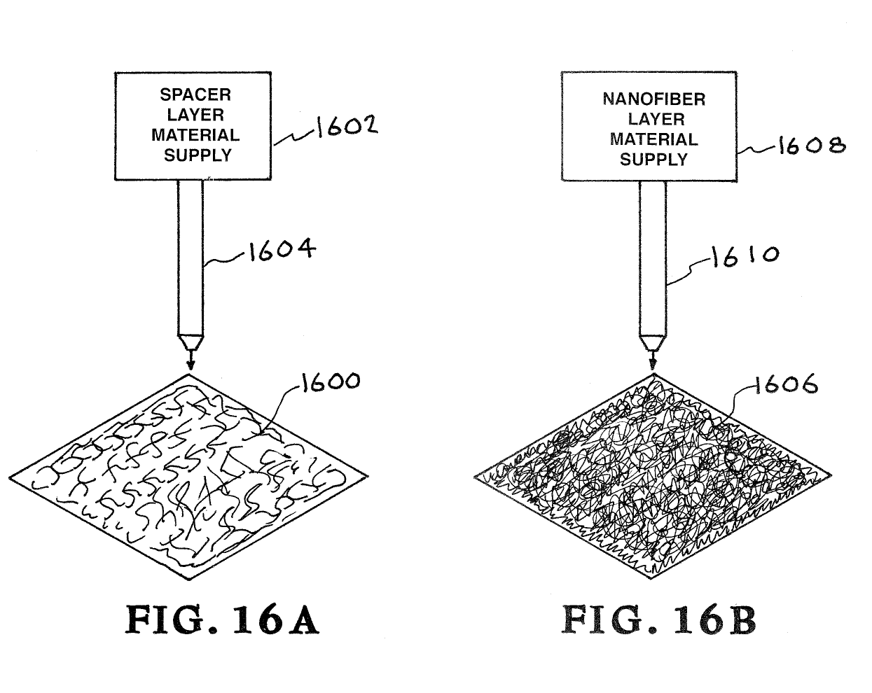

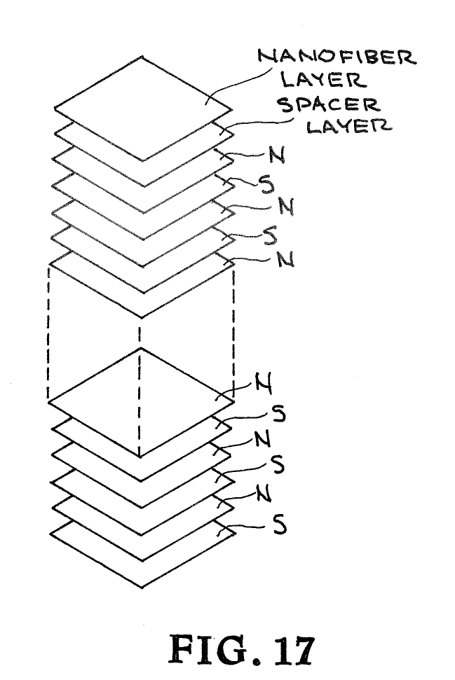

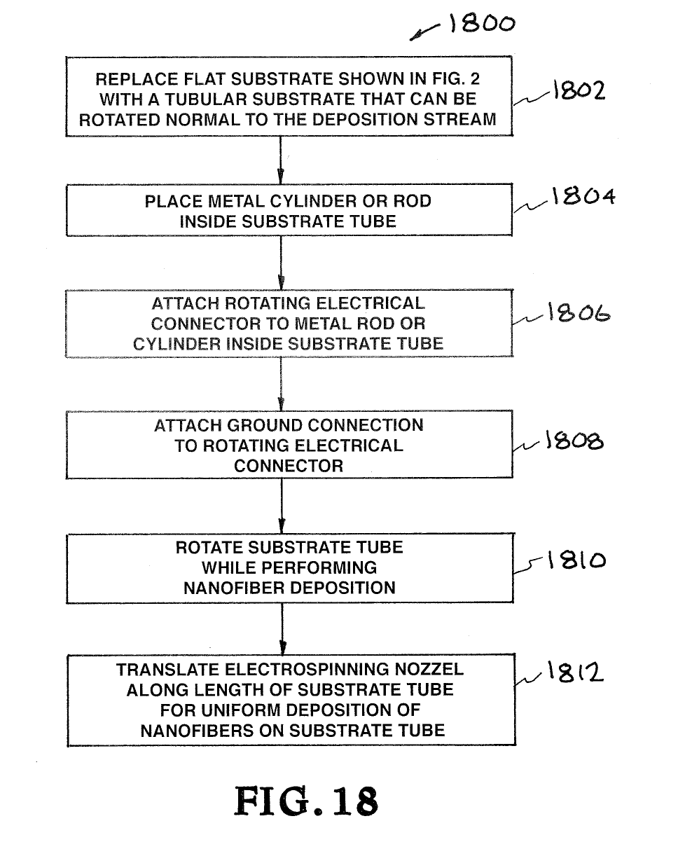

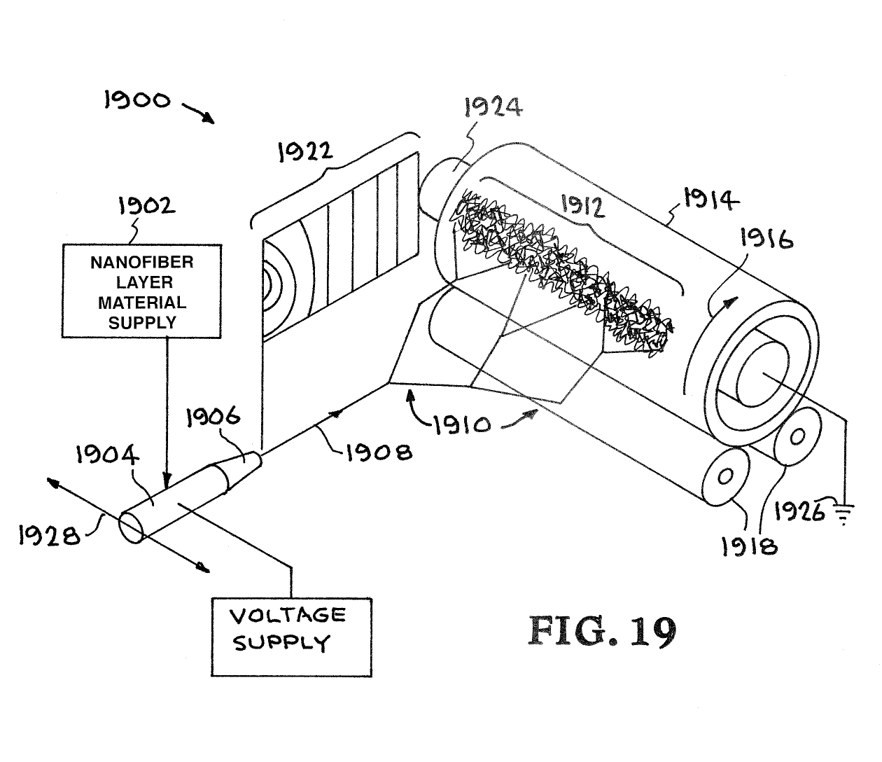

The production of the filter and the filter made by the multi-layer process are illustrated in FIGS. 16A, 16B, and 17. As shown in FIG. 16A, a spacer layer 1600 is produced using a spacer material supply 1602 and an extruder 1604 to extrude material to form the spacer layer 1600. As shown in FIG. 16B, a nanofiber layer 1606 is produced on the spacer layer 1600. An electrospinning unit 1610 contains a nanofiber material from a nanofiber material supply 1608 and electrospins the nanofiber material 1606 onto the ceramic substrate 1600 to produce the filter material. Additional spacer layers and additional nanofiber layers can be produce by repeated processing. The additional nanofiber layers can be made of materials other than nanofiber material.

Referring now to FIG. 17, an example of a multi-layer filter produced by the system described and shown in FIGS. 16A and 16B. The multi-layer filter is designated generally by the reference numeral 1700. The multi-layer filter 1700 includes a nanofiber layer on a spacer layer. Additional nanofiber layers (N) and spacer layers (S) makeup the multi-layer filter 1700.

Additional embodiments of the present invention include variations of the filter apparatus and method of making a filter apparatus. Some of the additional embodiments are described below. A filter apparatus for filtering fluid containing particles where a layer of fine fibers deposited by various methods is deposited on to a ceramic substrate followed by one or more layers of fibers of a different diameters or different fiber materials including larger fiber diameters. These layers may be in multiple repeating layers of the different fibers and the layers can be of varying thicknesses. A filter apparatus for filtering fluid containing particles where a layer of fine fibers deposited by various methods is deposited on to a ceramic substrate followed by one or more layers of chopped fibers of large diameter which chopped fibers have aspect ratios of length to diameter ranging from 1:1 to 200:1 or larger. These layers may be in multiple repeating layers of the different fibers and the layers can be of varying thicknesses. A filter apparatus for filtering fluid containing particles with the fibers of significantly different diameters being deposited concurrently by methods described herein such that the mesh of fine fibers (including nanofibers) is disrupted to allow some larger passages within the filter medium. This configuration provides for lower pressure drop while still obtaining the filtrations efficiency of the fine fibers including nanofibers. A filter apparatus for filtering fluid containing particles where a second type of fiber or particles with larger diameter is co-deposited or deposited in layers producing a microstructure which provides frequent separation between the nanofibers to facilitate a lower pressure drop while maintaining filtration efficiency and allowing for capture of significant numbers of particles without rapidly clogging the filter medium to maintain low pressure drop in the filter. The separation between the nanofibers in this apparatus in the case of co-deposition or between the layers of the nanofibers is desirably effectively many multiples of the nanofiber (or smallest fiber) diameters. In the case of co-deposition, the finest fibers need to be separated only frequently enough to prevent a dense web of fine fibers with small openings from being formed.

Referring now to FIG. 18, a flow chart illustrates a system for producing a filter material on a tubular filter. The system for producing a filter material on a tubular filter is designated generally by the reference numeral 1800. The system 1800 includes the following steps: Step 1802—Replace the flat substrate illustrated in FIG. 2 with a substrate tube normal to the deposition direction. Step 1804—Place a metal cylinder or rod inside the substrate tube. Step 1806—Attach a rotating electrical connector to the metal cylinder/rod inside the substrate tube. Step 1808—Attach a ground connection to the rotating electrical connector. Step 1810—Rotate the substrate tube while performing nanofiber deposition. Step 1812—Translate the electrospinning nozzle/needle along the length of tube as needed for uniform deposition of nanofibers onto the substrate tube.

FIG. 19 shows a system for producing a filter material on a tubular filter. The system is designated generally by the reference numeral 1900. The system 1900 uses electrospinning technology to form a matt 1912 of nanofibers on a tubular ceramic substrate 1914. A supply of nanofiber material 1902 is fed to an electrospinning unit having a nozzle 1904 where the nanofibers are ejected as a jet 1908. A voltage source provides a voltage supply to the electrospinning unit. The jet of nanofibers is directed toward the tubular ceramic substrate 1914. The tubular ceramic substrate 1914 acts as an electrically conductive collector through appropriate electrical connections 1926; alternatively it may not. The voltage source and the electrical connections create a constant electrical potential 1922 between the nozzle 1906 and the tubular ceramic substrate 1914. A conductive rod 1924 is attached to 1926. As the jet 1908 enters the electrical field it splays out (spinning 1910) and is deposited on the tubular ceramic substrate 1914. The matt 1912 of nanofiber material is produced on the tubular ceramic substrate 1914.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A filter apparatus for filtering a fluid containing particles, comprising:
a porous substrate, said porous substrate made of a porous ceramic material; and
a filtering material connected to said porous substrate, said filtering material including nanofibers; wherein the fluid travels through said porous substrate and travels through said filtering material, wherein the particles are captured in said filtering material.

2. The filter apparatus for filtering a fluid containing particles of claim 1 wherein the fluid travels through said porous substrate and travels through said filtering material, wherein the particles are captured in said porous substrate and in said filtering material.

3. The filter apparatus for filtering a fluid containing particles of claim 1 wherein said nanofibers in said filtering material have a diameter that is within the range of one nanometer to two hundred nanometers.

4. The filter apparatus for filtering a fluid containing particles of claim 1 wherein said nanofibers in said filtering material have a diameter that is within the range of five nanometers to two hundred nanometers.

5. The filter apparatus for filtering a fluid containing particles of claim 1 wherein said nanofibers in said filtering material have a diameter that is within the range of five nanometers to one hundred nanometers.

6. The filter apparatus for filtering a fluid containing particles of claim 1 wherein some of said nanofibers in said filtering material have a diameter that is within the range of five nanometers to two hundred nanometers and wherein some of said nanofibers in said filtering material have a diameter that is larger than two hundred nanometers.

7. The filter apparatus for filtering a fluid containing particles of claim 1 wherein some of said nanofibers in said filtering material have a diameter that is within the range of five nanometers to two hundred nanometers and wherein some of said nanofibers in said filtering material have a diameter that is within the range of two hundred nanometers to one micrometer.

8. The filter apparatus for filtering a fluid containing particles of claim 1 wherein said porous ceramic material of said porous substrate and said filtering material including nanofibers have structures that produce a pressure drop in the fluid that travels through said porous substrate and travels through said filtering material and said pressure drop is less than two inches of water column pressure drop.

9. The filter apparatus for filtering a fluid containing particles of claim 1 wherein said porous ceramic material of said porous substrate and said filtering material including nanofibers have structures that produce a pressure drop in the fluid that travels through said porous substrate and travels through said filtering material and said pressure drop is within the range of two to six inches of water column pressure drop.

10. The filter apparatus for filtering a fluid containing particles of claim 1 wherein said porous ceramic material of said porous substrate and said filtering material including nanofibers have structures that produce a pressure drop in the fluid that travels through said porous substrate and travels through said filtering material and said pressure drop is within the range of six to ten inches of water column pressure drop.

11. The filter apparatus for filtering a fluid containing particles of claim 1 wherein said porous ceramic material of said porous substrate and said filtering material including nanofibers have structures that produce a pressure drop in the fluid that travels through said porous substrate and travels through said filtering material and said pressure drop is greater than ten inches of water column pressure drop.

12. A filter apparatus for filtering a fluid containing particles, comprising:
porous substrate means made of a porous ceramic material for allowing passage of the fluid; and
filtering material means for filtering the fluid connected to said porous substrate means, said filtering material means including nanofibers; wherein the fluid travels through said porous substrate means and travels through said filtering material means, wherein the particles are captured in said filtering material means.

13. The filter apparatus for filtering a fluid containing particles of claim 12 wherein said nanofibers in said filtering material means have a diameter that is within the range of one nanometer to two hundred nanometers.

14. The filter apparatus for filtering a fluid containing particles of claim 12 wherein said porous ceramic material of said porous substrate means and said filtering material means including nanofibers have structures that produce a pressure drop in the fluid travels through said porous substrate means and travels through said filtering material means have structures that produce a pressure drop in the fluid less than two inches of water column pressure drop.

15. The filter apparatus for filtering a fluid containing particles of claim 12 wherein said porous ceramic material of said porous substrate means and said filtering material means including nanofibers have structures that produce a pressure drop in the fluid travels through said porous substrate means and travels through said filtering material means have structures that produce a pressure drop in the fluid within the range of two to ten inches of water column pressure drop.

16. A method of filtering a fluid containing particles, comprising the steps of:
providing a porous substrate made of a porous ceramic material;
providing a filtering material connected to said porous substrate wherein said filtering material includes nanofibers; and
directing the fluid through said porous substrate and through said filtering material wherein the particles are captured in said filtering material.

17. The method of filtering a fluid containing particles of claim 16 wherein said step of directing the fluid through said porous substrate and through said filtering material comprises directing the fluid through said porous substrate and directing the fluid through said filtering material wherein the particles are captured in said porous substrate and the particles are captured in said filtering material.

18. The method of filtering a fluid containing particles of claim 16 wherein said nanofibers in said filtering material have a diameter that is within the range of one nanometer to two hundred nanometers.

19. The method of filtering a fluid containing particles of claim 16 wherein said nanofibers in said filtering material have a diameter that is within the range of five nanometers to two hundred nanometers.

20. The method of filtering a fluid containing particles of claim 16 wherein said nanofibers in said filtering material have a diameter that is within the range of five nanometers to one hundred nanometers.

21. The method of filtering a fluid containing particles of claim 16 wherein some of said nanofibers in said filtering material have a diameter that is within the range of five nanometers to two hundred nanometers and wherein some of said nanofibers in said filtering material have a diameter that is larger than two hundred nanometers.

22. The method of filtering a fluid containing particles of claim 16 wherein some of said nanofibers in said filtering material have a diameter that is within the range of five nanometers to two hundred nanometers and wherein some of said nanofibers in said filtering material have a diameter that is within the range of two hundred nanometers to one micrometer.

23. The method of filtering a fluid containing particles of claim 16 wherein said porous ceramic material of said porous substrate and said filtering material including nanofibers have structures that produce a pressure drop in the fluid that travels through said porous substrate and travels through said filtering material and said pressure drop is within the range of two to six inches of water column pressure drop.

24. The method of filtering a fluid containing particles of claim 16 wherein said porous ceramic material of said porous substrate and said filtering material including nanofibers have structures that produce a pressure drop in the fluid that travels through said porous substrate and travels through said filtering material and said pressure drop is less than two inches of water column pressure drop.

25. The method of filtering a fluid containing particles of claim 16 wherein said porous ceramic material of said porous substrate and said filtering material including nanofibers have structures that produce a pressure drop in the fluid that travels through said porous substrate and travels through said filtering material and said pressure drop is within the range of six to ten inches of water column pressure drop.

26. The method of filtering a fluid containing particles of claim 16 wherein said porous ceramic material of said porous substrate and said filtering material including nanofibers have structures that produce a pressure drop in the fluid that travels through said porous substrate and travels through said filtering material and said pressure drop is greater than ten inches of water column pressure drop.

27. The method of filtering a fluid containing particles of claim 16 wherein said step of providing a porous substrate made of a porous ceramic material comprises extruding a stream of said ceramic material to form said porous substrate.

28. The method of filtering a fluid containing particles of claim 16 wherein said step of providing a porous substrate made of a porous ceramic material comprises providing said ceramic material on a supply of ceramic substrate to form said porous substrate.

29. The method of filtering a fluid containing particles of claim 16 wherein said step of providing a filtering material connected to said porous substrate comprises electrospinning a jet of nanofibers to provide said filtering material.

30. The method of filtering a fluid containing particles of claim 16 wherein said step of providing a filtering material connected to said porous substrate comprises depositing a first layer of fibers on said porous substrate followed by depositing one or more additional layers of fibers on said porous substrate.

31. The method of filtering a fluid containing particles of claim 30 wherein said step of depositing one or more additional layers of fibers on said porous substrate comprises depositing one or more additional layers of fibers of different diameters on said porous substrate.

32. The method of filtering a fluid containing particles of claim 30 wherein said step of depositing one or more additional layers of fibers on said porous substrate comprises depositing one or more additional layers of fibers of different diameters or different fiber materials in multiple repeating layers wherein said layers have varying thicknesses.

33. The method of filtering a fluid containing particles of claim 30 wherein said step of depositing one or more additional layers of fibers on said porous substrate comprises depositing one or more layers of chopped fibers on said porous substrate.

34. The method of filtering a fluid containing particles of claim 30 wherein said step of depositing one or more additional layers of fibers on said porous substrate comprises depositing one or more layers of chopped fibers on said porous substrate wherein said chopped fibers have aspect ratios of length to diameter ranging from 1:1 to 200:1 or larger.

35. A method of filtering a fluid containing particles, comprising the steps of:
providing a porous substrate made of a porous ceramic material;
providing a filtering material including nanofibers connected to said porous substrate wherein said filtering material is provided by depositing a first layer of fibers on said porous substrate followed by depositing one or more additional layers of fibers on said porous substrate or on said first layer wherein said first layer or said one or more additional layers or both said first layer and said one or more additional layers include fibers of different diameters; and
directing the fluid through said porous substrate and through said filtering material wherein some of the particles are captured in said filtering material and wherein some of the particles pass through said first layer or said one or more additional layers or both said first layer and said one or more additional layers that include fibers of different diameters.

36. A method of filtering a fluid containing particles, comprising the steps of:
providing a porous substrate made of a porous ceramic material;
providing a filtering material connected to said porous substrate wherein said filtering material is provided by depositing a first layer of filter material on said porous substrate followed by depositing one or more additional layers of filter material on said porous substrate or on said first layers of filter material wherein said first layer of filter material or said additional layers of filter material or both said first layer of filter material and said additional layers of filter material include nanofibers; and
directing the fluid through said porous substrate and through said first layer of filtering material and said additional layers of filtering material wherein some of the particles are captured in said first layer of filtering material and wherein some of the particles pass through said first layer of filtering material.

37. The method of filtering a fluid containing particles of claim 36 wherein said step of depositing a first layer of filter material on said porous substrate followed by depositing one or more additional layers of filter material on said porous substrate or on said first layers of filter material includes depositing fibers of different diameters.

38. The method of filtering a fluid containing particles of claim 36 wherein said step of depositing a first layer of filter material on said porous substrate followed by depositing one or more additional layers of filter material on said porous substrate or on said first layers of filter material includes depositing a first type of fiber and depositing a different type of fiber.

39. The method of filtering a fluid containing particles of claim 36 wherein said step of depositing a first layer of filter material on said porous substrate followed by depositing one or more additional layers of filter material on said porous substrate or on said first layers of filter material includes depositing a fiber and depositing a material that is not a fiber.
